(19) United States
(12) Patent Application Publication
(10) Pub. No.: US 2026/0104489 A1
(43) Pub. Date: Apr. 16, 2026

(54) PERSON ANALYZING SYSTEM, PERSON ANALYZING METHOD, AND PERSON ANALYZING PROGRAM

(71) Applicant: PANASONIC INTELLECTUAL PROPERTY MANAGEMENT CO., LTD., Osaka (JP)

(72) Inventors: Kosuke ONO, Kanagawa (JP); Makoto YASUGI, Tokyo (JP); Hiroshi NOGUCHI, Kanagawa (JP)

(73) Assignee: PANASONIC INTELLECTUAL PROPERTY MANAGEMENT CO., LTD., Osaka (JP)

(21) Appl. No.: 19/141,773

(22) PCT Filed: Dec. 21, 2023
(86) PCT No.: PCT/JP2023/046032

§ 371 Date: Jun. 20, 2025

(30) Foreign Application Priority Data
Dec. 23, 2022 (JP) 2022-207036

(51) Int. Cl. G01S 7/41; G01S 7/04; G01S 13/72; G06T 7/246; G06T 7/73

(52) U.S. Cl. CPC G01S 7/417; G01S 7/046; G01S 13/726; G06T 7/251; G06T 7/75; G06T 2207/10016; G06T 2207/10028; G06T 2207/20084; G06T 2207/30196

(57) ABSTRACT

Position detection and action estimation are performed for each of a plurality of persons by using a sensor that detects a person by emitting radio waves. A person analysis system includes at least one radar device installed in a monitoring area and configured to output observation data including a result of observing the monitoring area by a radar method, and a person analysis device configured to execute, based on the observation data, a first process of detecting a position of each person present in the monitoring area and a second process of estimating an action of the detected person, and display information indicating the position and the action of the person on a predetermined display device.

### TECHNICAL FIELD

The present disclosure relates to a person analysis system, a person analysis method, and a person analysis program.

### BACKGROUND ART

As a sensor capable of detecting a person present in a room while protecting privacy, a sensor that detects a person using microwaves is known. Patent Literature 1 discloses that a frequency modulated continuous wave (FMCW) sensor is used to calculate an intensity sum of at least a part of frequency components among all frequency components in a frequency spectrum of a generated beat signal, determine that an object is present in a room when the intensity sum is smaller than a predetermined value, detect a position of a person based on a spectral distribution of the generated beat signal, and estimate a state of the person (for example, if the person had fallen).

### CITATION LIST

### Patent Literature

Patent Literature 1: JP2016-138796A

### SUMMARY OF INVENTION

### Technical Problem

However, Patent Literature 1 does not disclose estimating actions of each of a plurality of persons (that is, what the person is doing).

An object of the present disclosure is to provide a technique for performing position detection and action estimation for each of a plurality of persons using a sensor that detects a person by emitting radio waves.

### Solution to Problem

A person analysis system according to an aspect of the present disclosure includes: at least one radar device installed in a monitoring area and configured to output observation data including a result of observing the monitoring area by a radar method; and a person analysis device configured to execute, based on the observation data, a first process of detecting a position of each person present in the monitoring area and a second process of estimating an action of the detected person, and display information indicating the position and the action of the person on a predetermined display device.

A person analysis method according to an aspect of the present disclosure includes: acquiring observation data including a result of observing a monitoring area by a radar method from at least one radar device installed in the monitoring area; executing a first process of detecting a position of each person present in the monitoring area and a second process of estimating an action of the detected person based on the observation data; and displaying information indicating the position and the action of the person on a predetermined display device.

A person analysis program according to an aspect of the present disclosure causes a computer to execute the above person analysis method.

These comprehensive or specific aspects may be implemented by a system, a device, a method, an integrated circuit, a computer program, a recording medium, or any combination of the system, the device, the method, the integrated circuit, the computer program, and the recording medium.

### Advantageous Effects of Invention

According to the present disclosure, it is possible to perform position detection and action estimation for each of a plurality of persons using a sensor that detects a person by emitting radio waves.

### BRIEF DESCRIPTION OF DRAWINGS

FIG. 1 is a diagram illustrating a configuration example of a person analysis system according to an embodiment;

FIG. 2 is a diagram illustrating a display example of a display device according to the embodiment;

FIG. 3 is a diagram illustrating a configuration example of a person analysis device according to the present embodiment;

FIG. 4 is a diagram illustrating an example of information included in each piece of data according to the present embodiment;

FIGS. 5A to 5C are diagrams illustrating an example of analyzing appropriateness of an action of a person according to the present embodiment;

FIGS. 6A to 6C are diagrams illustrating an example of analyzing a physical condition of a person according to the present embodiment;

FIGS. 7A to 7C are diagrams illustrating an example of displaying a designated action according to the present embodiment;

FIGS. 8A to 8C are diagrams illustrating a display example of estimation accuracy of an action according to the present embodiment;

FIG. 9 is a diagram illustrating an example of a screen for setting a display condition of appropriateness of an action according to the present embodiment;

FIG. 10 is a diagram illustrating an example of a screen for setting a display condition of the physical condition according to the present embodiment;

FIG. 11 is a diagram illustrating an example of a screen for selecting a use according to the present embodiment;

FIG. 12 is a diagram illustrating an example of a screen for setting detection sensitivity according to the present embodiment; and

FIG. 13 is a diagram illustrating a hardware configuration example of an information processing device (computer) that realizes functional blocks of the person analysis device according to the present disclosure by a computer program.

### DESCRIPTION OF EMBODIMENTS

Hereinafter, an embodiment of the present disclosure will be described in detail with reference to the drawings as appropriate. However, unnecessarily detailed description may be omitted. For example, detailed description of already well-known matters and redundant description of substantially the same configuration may be omitted. This is to avoid unnecessary redundancy of the following description and to facilitate understanding of those skilled in the art. The accompanying drawings and the following description are provided for those skilled in the art to sufficiently understand the present disclosure, which are not intended to limit the subject matter described in the claims.

### Present Embodiment

### <Configuration of Person Analysis System>

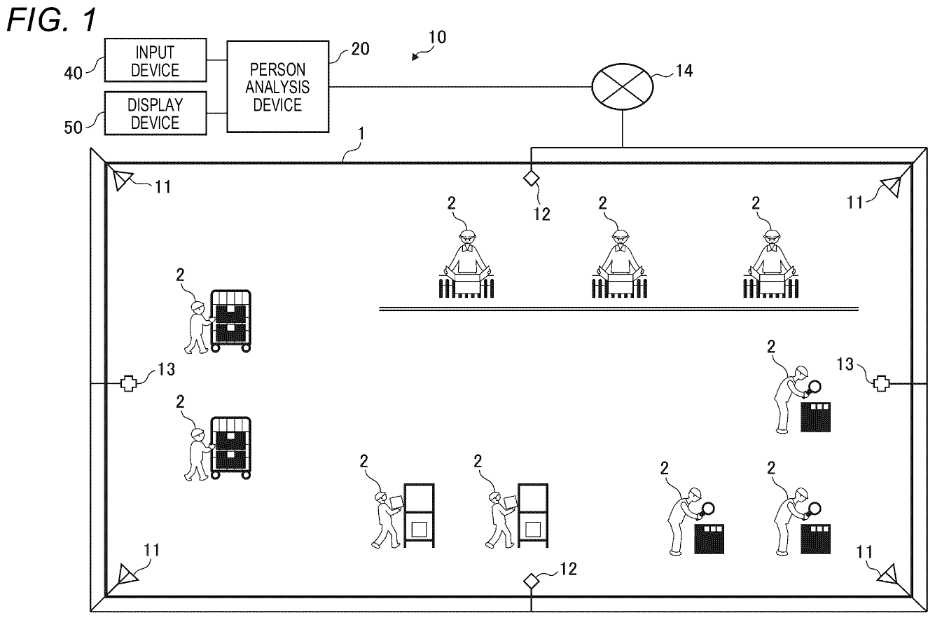

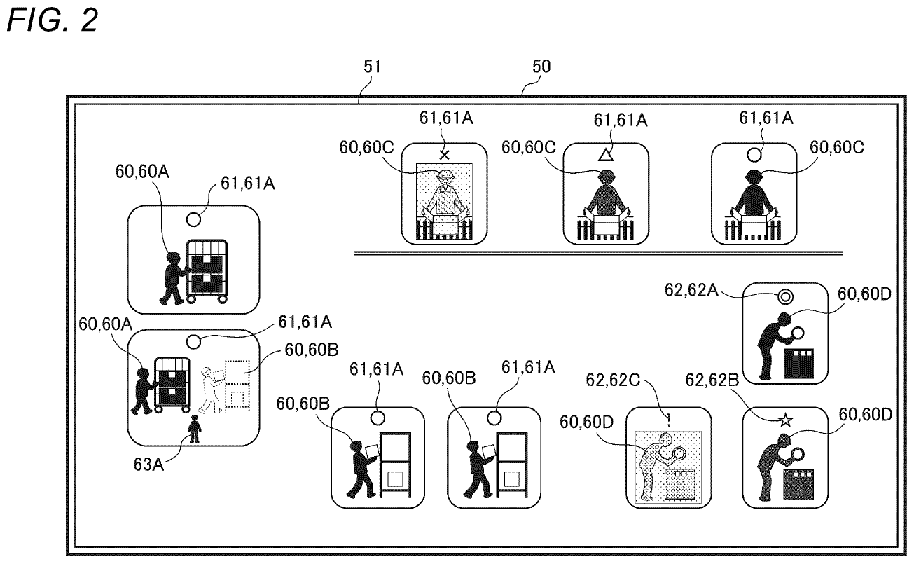

FIG. 1 is a diagram illustrating a configuration example of a person analysis system 10 according to an embodiment. FIG. 2 is a diagram illustrating a display example of a display device 50 according to the embodiment.

As illustrated in FIG. 1, the person analysis system 10 includes radar devices 11, thermal sensors 12, environment sensors 13, a person analysis device 20, an input device 40, and the display device 50.

The person analysis device 20 may transmit and receive data to and from at least one of the radar device 11, the thermal sensor 12, and the environment sensor 13 through a communication network 14. The communication network 14 may be, for example, a wired local area network (LAN), a wireless LAN, the Internet, a virtual private network (VPN), and the like.

The input device 40 and the display device 50 are connected to the person analysis device 20. Examples of the input device 40 include a keyboard, a mouse, a touch pad, a microphone, or a tablet terminal. Examples of the display device 50 include a liquid crystal display, an organic EL display, and a tablet terminal.

The radar device 11 is an example of a radar type sensor, and at least one radar device 11 is installed in a monitoring area 1. The radar device 11 emits radio waves (radar) and receiving reflected waves to observe positions or the like of persons 2 or objects (not illustrated) present in the monitoring area 1, and generates observation data including an observation result. For example, the radar device 11 transmits radio waves (radar) obtained by performing frequency modulated continuous wave (FMCW) modulation on a signal of a wide band (for example, 7 MHz) in a millimeter wave band (for example, a 60 GHz band or a 79 GHz band) as a radar system using a multi input multi output (MIMO) antenna. Then, the radar device 11 receives the reflected waves of the transmitted radio waves reflected by a person or an object using the MIMO antenna. The radar device 11 generates a beat signal, which is an example of the observation data, based on a difference signal between the transmitted signal and the received signal. The beat signal may be configured as in-phase/quadrature-phase (IQ) data. The radar device 11 transmits the IQ data to the person analysis device 20. Also, the radar device 11 may be a light detection and ranging (LiDAR).

At least one thermal sensor 12 is installed in the monitoring area 1. The thermal sensor 12 measures a body temperature of each person 2 present in the monitoring area 1 by measuring infrared rays radiated from an object, and generates thermal data including the measurement result. The thermal sensor 12 transmits the generated thermal data to the person analysis device 20.

At least one environment sensor 13 is installed in the monitoring area 1. The environment sensor 13 measures, for example, at least one of an illuminance of the monitoring area 1, the illuminance and an illumination color of the monitoring area 1, the temperature and a humidity of the monitoring area 1, a magnitude of noise in the monitoring area 1, and a type of odor in the monitoring area 1, and generates environment data including the measurement result. The environment sensor 13 transmits the generated environment data to the person analysis device 20. The environment sensor 13 may be different for each target to be measured, or one environment sensor 13 may measure a plurality of targets to be measured.

The person analysis device 20 executes a first process of detecting the position of each person 2 present in the monitoring area 1 and a second process of estimating the action of each detected person 2 based on the observation data received from the radar device 11, and displays information indicating the position and the action of each person 2 on the display device 50. For example, as illustrated in FIG. 2, the person analysis device 20 displays an area map 51 corresponding to the monitoring area 1, and displays a pictogram 60 indicating the estimated action of the person 2 at the position of the detected person 2 in the area map 51. Accordingly, the user who is checking the display device 50 can confirm at a glance at which position each person 2 present in the monitoring area 1 is performing what kind of action. Details of the person analysis device 20 and details of information displayed on the display device 50 illustrated in FIG. 2 will be described later.

Hereinafter, an example in which the “monitoring area” is a warehouse, the “person” is a worker working in the warehouse, and the “action” is a representative work performed by the worker in the warehouse will be described. In addition, as types of actions, a work of transporting a load (hereinafter referred to as “transport”), a work of collecting a load (hereinafter referred to as “collection”), a work of packing a load (hereinafter referred to as “packing”), and a work of inspecting a load (hereinafter referred to as “inspection”) will be described as examples.

In this case, as illustrated in FIG. 2, the person analysis device 20 displays the pictogram 60 indicating the action of the person 2 at the position where the person 2 is present in the area map 51 of the warehouse. For example, when estimating the action of a certain person 2 as “transport”, the person analysis device 20 displays a pictogram 60A indicating “transport” at the position where the person 2 is present in the area map 51 of the warehouse. When estimating the action of a certain person 2 as “collection”, the person analysis device 20 displays a pictogram 60B indicating “collection” at the position where the person 2 is present in the area map 51 of the warehouse. When specifying the action of a certain person 2 as “packing”, the person analysis device 20 displays a pictogram 60C indicating “packing” at the position where the person 2 is present in the area map 51 of the warehouse. When specifying the action 2 of a certain person as “inspection”, the person analysis device 20 displays a pictogram 60D indicating “inspection” at the position where the person is present in the area map 51 of the warehouse.

As a result, the user who is checking the display device 50 can easily confirm at which position each person 2 working in the warehouse is performing what kind of action by viewing the pictogram 60 displayed on the display device 50. The pictogram 60 indicating the action of the person 2 is not limited thereto, and for example, an avatar corresponding to the person may be set and displayed by an animation indicating the motion of the person.

The monitoring area 1 is not limited to the warehouse, and may be, for example, a factory, a store, a hospital, a convenience store, a department store, an office, a school, a home, or a room. In addition, the type of action may be any type as long as it is a representative action performed by a person in the monitoring area 1, and the type of action may be different when the monitoring area 1 is different.

Hereinafter, the person analysis system 10 according to the present embodiment will be described in more detail.

### <Configuration of Person Analysis Device>

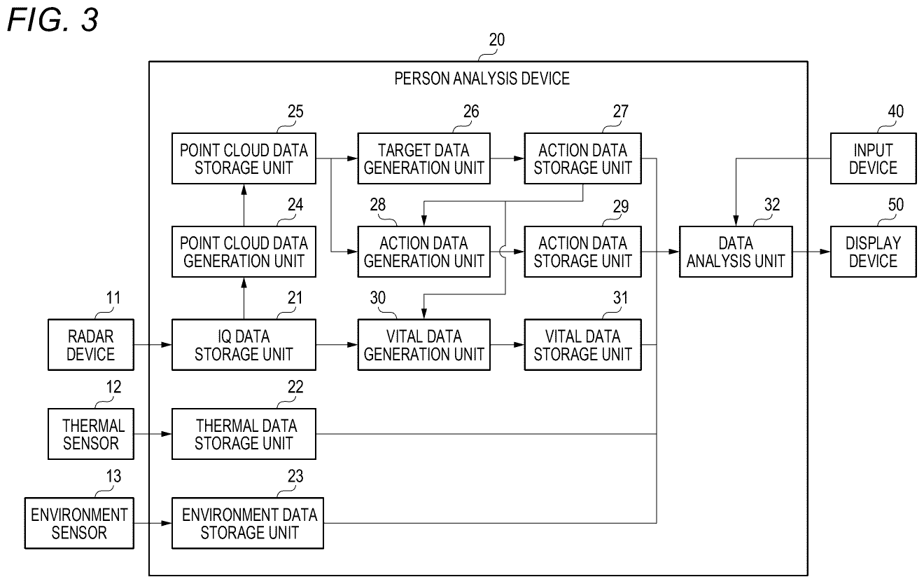

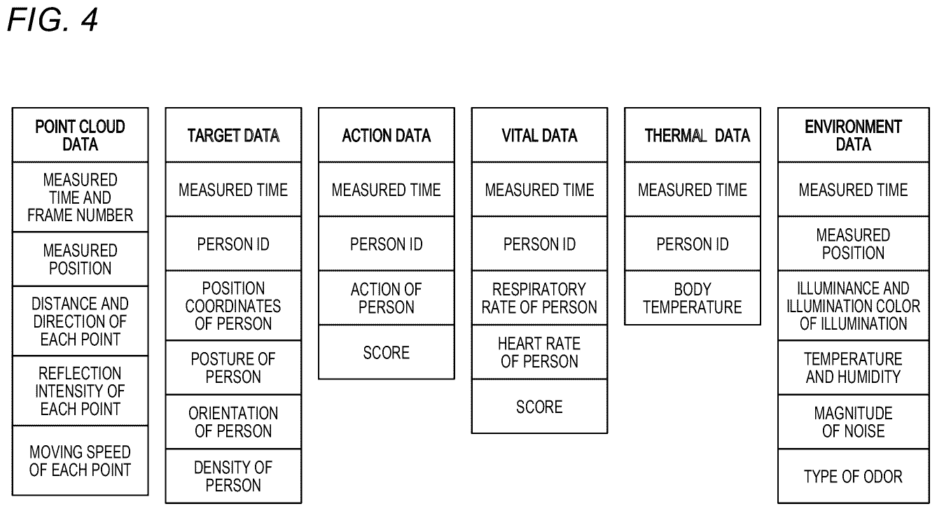

FIG. 3 is a diagram illustrating a configuration example of the person analysis device 20 according to the present embodiment. FIG. 4 is a diagram illustrating an example of information included in each piece of data according to the present embodiment.

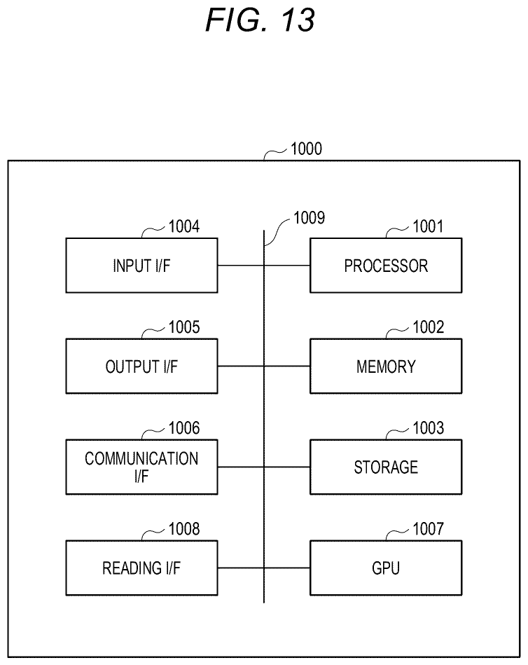

The person analysis device 20 includes, as functions, an IQ data storage unit 21, a thermal data storage unit 22, an environment data storage unit 23, a point cloud data generation unit 24, a point cloud data storage unit 25, a target data generation unit 26, a target data storage unit 27, an action data generation unit 28, an action data storage unit 29, a vital data generation unit 30, a vital data storage unit 31, and a data analysis unit 32. As illustrated in FIG. 13, the person analysis device 20 includes at least a processor 1001 and a memory 1002, and the functions of the person analysis device 20 described above may be realized by the processor 1001 reading and executing a predetermined computer program from the memory 1002.

The IQ data storage unit 21 stores IQ data periodically transmitted from the radar device 11.

The thermal data storage unit 22 stores thermal data periodically transmitted from the thermal sensor 12. As illustrated in FIG. 4, the thermal data may include a measured time, a person ID for identifying each person 2, and the measured body temperature of each person 2.

The environment data storage unit 23 stores environment data periodically transmitted from the environment sensor 13. As illustrated in FIG. 4, the environment data may include at least one of a measured time, a measured position, information indicating an illuminance and an illumination color of the illumination, a temperature and a humidity, a magnitude of noise, and a type of odor.

### <Point Cloud Data Generation Unit>

The point cloud data generation unit 24 generates three-dimensional point cloud data using the IQ data in the IQ data storage unit 21, and stores the three-dimensional point cloud data in the point cloud data storage unit 25. As illustrated in FIG. 4, the point cloud data may include a measured time and a frame number, a position at which the point cloud data is measured (that is, a position of the radar device 11), position coordinates (x, y, z) of each point, a reflection intensity of each point, and a moving direction and a moving speed of each point. Each point included in the point cloud data may be a point at which the reflection intensity is equal to or greater than a predetermined threshold value (that is, a point estimated not to be noise) or an operating point at which the moving speed is equal to or greater than a predetermined threshold value. One point indicates position coordinates (x, y, z) of a reflection point on a surface of the person 2 or an object (not illustrated). The moving direction and the moving speed of the point can be obtained by measuring the Doppler velocity after repeatedly capturing the reflected waves from a plurality of directions for a certain period of time by emitting modulated radio waves. When the LiDAR is used for the radar device 11, the moving speed of the point can be obtained by modulating the laser and measuring the Doppler velocity. The information including the position coordinates of each point may be expressed as coordinate information. The information including the moving direction and the moving speed of each point may be expressed as motion information.

### <Target Data Generation Unit>

The target data generation unit 26 uses the point cloud data in the point cloud data storage unit 25 to detect the position where each person is present in the warehouse, a posture and an orientation of each person 2, and a density of each person 2. The target data generation unit 26 generates target data based on the detection result and stores the target data in the target data storage unit 27. As illustrated in FIG. 4, the target data may include a measured time, the person ID for identifying the person 2, the position coordinates (x, y, z) of the person 2 in the warehouse, the posture of the person 2, the orientation of the person 2, and the density of the person 2. The density of the person 2 is an index indicating a distance between the person 2 and another person 2. In the present embodiment, “standing”, “sitting”, and “lying” will be described as examples of the types of posture. Further, in the present embodiment, “forward”, “lateral”, and “oblique” will be described as examples of the types of orientation. Further, in the present embodiment, “one person”, “multiple distant”, and “multiple close proximity” will be described as examples of types of density. The density of “one person” indicates that there is no other person 2 within a range of a predetermined distance from the person 2. The density of “multiple distant” indicates that although another person 2 is present within the range of the predetermined distance from the person 2, the distance to the other person 2 is equal to or greater than a predetermined threshold value. The density of “multiple close proximity” indicates that another person 2 is present within the range of the predetermined distance from the person 2 and the distance to the other person 2 is less than the predetermined threshold value.

For example, the target data generation unit 26 inputs the point cloud data to a deep neural network (DNN) for a 3D point cloud, and estimates the position coordinates, the posture, and the orientation of each person 2 based on an output result from the DNN for the 3D point cloud. The DNN for the 3D point cloud may be trained in advance using the point cloud data and a plurality of pieces of labeled training data that correspond to the position coordinates, the posture, and the orientation of the person 2 that are correct for a distribution of the point cloud indicated by the point cloud data. Examples of the DNN for the 3D point cloud include PointNet, VoxelNet, and PointPillars. The process of the target data generation unit 26 may be read as the first process. The DNN for the 3D point cloud may be read as a first neural network. The target data generation unit 26 includes the estimated position coordinates, posture, and orientation in the target data.

The target data generation unit 26 may assign the person ID to each person 2 present at the estimated position coordinates and include the person ID in the target data. The target data generation unit 26 may calculate the distance between the persons 2 from the estimated position coordinates of the persons 2 and determine the density of each person 2 based on the calculated distance. Then, the target data generation unit 26 may include the determination result of the density in the target data.

### <Action Data Generation Unit>

The action data generation unit 28 estimates the action of the person 2 using the target data in the target data storage unit 27 and the point cloud data in the point cloud data storage unit 25. The action data generation unit 28 generates action data based on the estimated result and stores the action data in the action data storage unit 29. For example, as illustrated in FIG. 4, the action data may include a measured time, the person ID for identifying the person 2, an estimated action of the person 2, and a score indicating reliability of the estimation (for example, estimation accuracy or likelihood). In the present embodiment, a higher score indicates a higher possibility that the estimated action is correct, and a lower score indicates a lower possibility that the estimated action is correct. In the present embodiment, as described above, “transport”, “collection”, “packing”, and “inspection”are given as examples of the types of actions.

For example, the action data generation unit 28 specifies the position of the person 2 and a body part (for example, a hand, an arm, a head, or a leg) of the person based on the target data, and generates pseudo image data of a portion corresponding to each part of the point cloud data of the person 2. Then, the action data generation unit 28 inputs the pseudo image data to a recursive DNN in time series, and estimates the type of action of the person 2 based on the output result from the recursive DNN. For example, the recursive DNN outputs a score for each type of action as an output result, and the action data generation unit 28 estimates the type of action having the highest output score as the action of the person 2.

The recursive DNN may be trained in advance using a plurality of pieces of labeled training data in which a temporal change in pseudo image data is associated with a correct action of a person for the temporal change in the pseudo image data. Examples of the recursive DNN include a long short term memory (LSTM) and a gated recurrent unit (GRU). The process of the action data generation unit 28 may be read as the second process. The recursive DNN may be read as a second neural network.

### <Vital Data Generation Unit>

The vital data generation unit 30 estimates a vital sign of the person 2 using the target data in the target data storage unit 27 and the IQ data in the IQ data storage unit 21. The vital data generation unit 30 generates vital data based on the estimated result, and stores the vital data in the vital data storage unit 31. As illustrated in FIG. 4, the vital data may include a measured time, the person ID for identifying the person 2, an estimated respiratory rate, an estimated heart rate, and a score indicating reliability of the estimation (for example, estimation accuracy or likelihood).

For example, the vital data generation unit 30 specifies the position of each person 2 based on the target data, and specifies the chest of the person 2 present at the specified position. Then, the vital data generation unit 30 calculates a slight periodic motion of a body surface of the person 2 based on the temporal change in phase information of a portion corresponding to the chest of the IQ data, and estimates the respiratory rate and the heart rate based on the periodic motion. The vital data generation unit 30 may estimate the respiratory rate and the heart rate by performing spectrum analysis and/or deep learning analysis.

For example, the vital data generation unit 30 may calculate a score of the estimated respiratory rate and/or heart rate based on a signal-noise ratio (SN ratio) related to the IQ data. For example, the vital data generation unit 30 increases the score as the SN ratio increases, and decreases the score as the SN ratio decreases. This is because when the SN ratio is small, a noise component is large and the estimation accuracy may decrease. The vital data generation unit 30 includes the calculated score in the vital data.

Note that the vital data generation unit 30 may estimate a blood pressure and the like by a similar method. In this case, the vital data illustrated in FIG. 4 may include the blood pressure and the like.

### <Data Analysis Unit>

The data analysis unit 32 performs various analyses on each person 2 using at least one of the target data in the target data storage unit 27, the action data in the action data storage unit 29, and the vital data in the vital data storage unit 31. Further, when performing the analysis, the data analysis unit 32 may further use the thermal data in the thermal data storage unit 22 and/or the environment data in the environment data storage unit 23. Next, an analysis example by the data analysis unit 32 will be described.

### <Analysis of Appropriateness of Action>

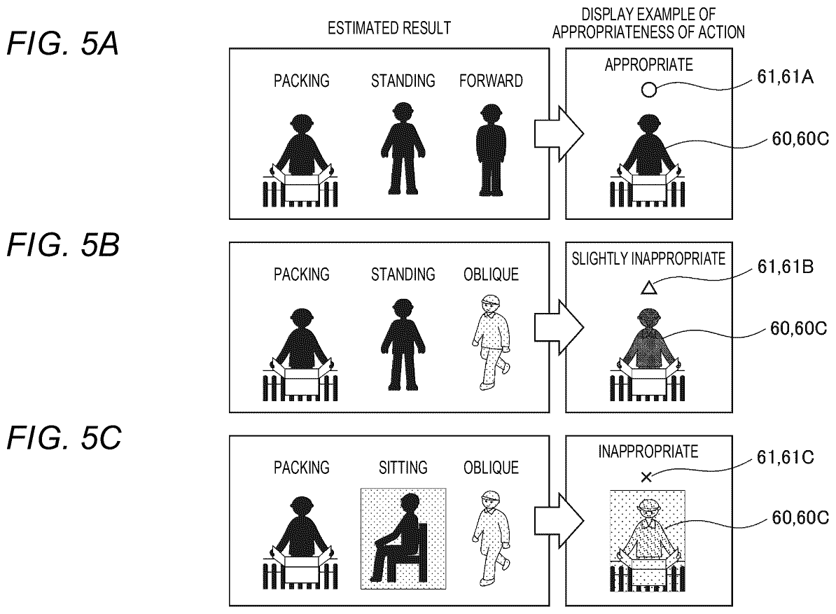

FIGS. 5A to 5C are diagrams illustrating an example of analyzing appropriateness of the action of the person 2 according to the present embodiment.

The data analysis unit 32 specifies the action of the person 2 from the action data in the action data storage unit 29. The data analysis unit 32 specifies the posture and orientation of the person 2 from the target data in the target data storage unit 27. The data analysis unit 32 determines the appropriateness of the action of the person 2 based on the specified posture and orientation with respect to the specified action.

For example, it is assumed that the ideal posture and orientation when the person 2 performs the action of “packing” are “standing” and “forward”, respectively. In this case, the data analysis unit 32 performs, for example, the following processes (A1) to (A3).
(A1) In a case where the data analysis unit 32 specifies the action of the person 2 as “packing”, specifies the posture of the person as “standing”, and specifies the orientation of the person 2 as “forward”, the data analysis unit 32 determines the action of the person 2 as “appropriate” since the action matches the ideal posture and orientation described above. Then, as illustrated in FIG. 5A, the data analysis unit 32 displays the pictogram 60C indicating the action of “packing” of the person 2 and a “○” mark 61A indicating that the action is “appropriate”.
(A2) In a case where the data analysis unit 32 specifies the action of the person 2 as “packing”, specifies the posture of the person 2 as “standing”, and specifies the orientation of the person 2 as “oblique”, the data analysis unit 32 determines the action of the person 2 as “slightly inappropriate” since the action matches the ideal posture described above with respect to the action but does not match the ideal orientation. Then, as illustrated in FIG. 5B, the data analysis unit 32 displays the pictogram 60C indicating the action of “packing” of the person 2 and a “Δ” mark 61B indicating that the action is “slightly inappropriate”. At this time, the data analysis unit 32 may display a color of the pictogram 60C indicating the action of “packing” of the person 2 in a color associated in advance with the action of “slightly inappropriate”.
(A3) In a case where the data analysis unit 32 specifies the action of the person 2 as “packing”, specifies the posture of the person 2 as “sitting”, and specifies the orientation of the person 2 as “oblique”, the data analysis unit 32 determines the action of the person 2 as “inappropriate” since neither the ideal posture nor the ideal orientation matches the action. Then, as illustrated in FIG. 5C, the data analysis unit 32 displays the pictogram 60C indicating the action of “packing” of the person 2 and a “x” mark 61C indicating that the action is “inappropriate”. At this time, the data analysis unit 32 may display the color of the pictogram 60C indicating the action of “packing” of the person 2 in a color associated in advance with the action of “inappropriate”.

As a result, the user can easily confirm at which position each person 2 working in the warehouse is performing what kind of action and whether the person 2 is taking an appropriate action by viewing the pictogram 60 and the mark 61 displayed on the display device 50.

The expression “pictogram” is an example, and any expression such as an illustration, a photograph, a symbol, or a sign may be used as long as the type of action can be distinguished. In addition, the expression “mark” is an example, and any expression such as a character, a number, a sign, a pattern, or a pictogram may be used as long as the appropriateness of the action can be distinguished.

### <Analysis of Physical Condition>

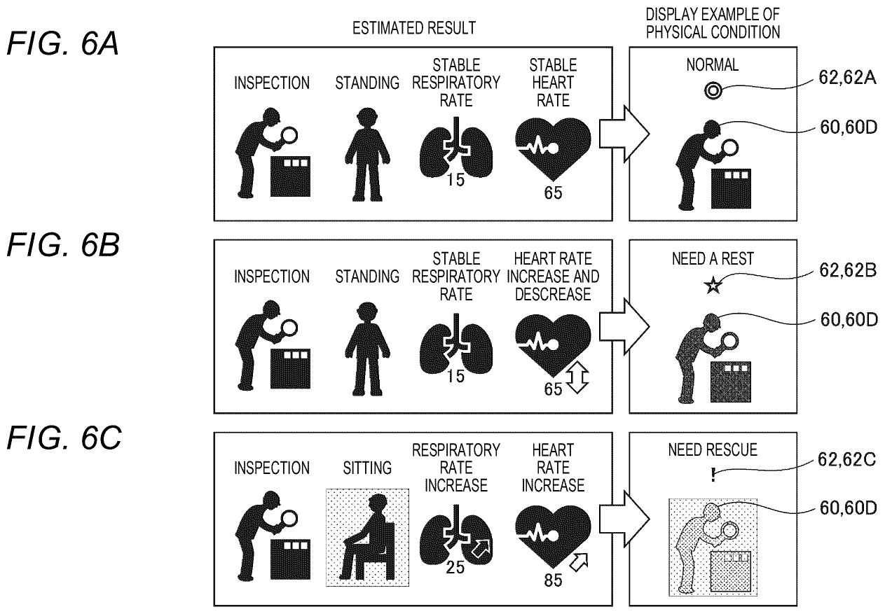

FIGS. 6A to 6C are diagrams illustrating an example of analyzing the physical condition of the person 2 according to the present embodiment.

The data analysis unit 32 specifies the action of the person 2 from the action data in the action data storage unit 29. The data analysis unit 32 specifies the posture of the person 2 from the target data in the target data storage unit 27. The data analysis unit 32 specifies a temporal change in the respiratory rate of the person 2 and a temporal change in the heart rate of the person 2 from the vital data in the vital data storage unit 31. The data analysis unit 32 determines the physical condition of the person at the time of the action based on the specified posture and the specified temporal changes in the respiratory rate and the heart rate with respect to the specified action.

For example, it is assumed that the normal posture when the person 2 performs the action of “inspection” is “standing”, and the temporal changes in the normal respiratory rate and heart rate are relatively small (that is, stable). Here, a relatively small temporal change in the respiratory rate means that the respiratory rate is within a predetermined normal range (for example, from an upper limit threshold value to a lower limit threshold value) in a predetermined time, and a relatively large temporal change in the respiratory rate may mean that the respiratory rate is not within the normal range (for example, greater than the upper limit threshold value or smaller than the lower limit threshold value). Similarly, a relatively small temporal change in the heart rate means that the heart rate is within a predetermined normal range (for example, from an upper limit threshold value to a lower limit threshold value) in a predetermined time, and a relatively large temporal change in the heart rate may mean that the heart rate is not within the normal range (for example, greater than the upper limit threshold value or smaller than the lower limit threshold value). In this case, the data analysis unit 32 performs, for example, the following processes (B1) to (B3).
(B1) In a case where the data analysis unit 32 specifies the action of the person 2 as “inspection”, specifies the posture of the person 2 as “standing”, and specifies that the temporal changes in the respiratory rate and the heart rate of the person 2 are relatively small (that is, stable), the data analysis unit 32 determines that the physical condition of the person 2 is “normal” since the posture matches the normal posture described above for the action and the respiratory rate and the heart rate match the normal respiratory rate and heart rate described above for the action. Then, the data analysis unit 32 displays the pictogram 60D indicating the action of “inspection” of the person 2 and a “⊚” mark 62A indicating that the physical condition is “normal”.
(B2) In a case where the data analysis unit 32 specifies the action of the person 2 as “inspection”, specifies the posture of the person 2 as “standing”, specifies the temporal change in the respiratory rate of the person 2 as relatively small (that is, stable), and specifies the temporal change in the heart rate of the person 2 as relatively large (for example, the heart rate repeatedly increases and decreases and is unstable), the data analysis unit 32 determines that the physical condition of the person 2 is “need a rest” since the posture matches the normal posture described above for the action, and the respiratory rate matches the normal respiratory rate described above for the action but the heart rate does not match the normal heart rate described above for the action. Then, the data analysis unit 32 displays the pictogram 60D indicating the action of “inspection” of the person 2 and a “☆” mark 62B indicating that the physical condition is “need a rest”. At this time, the data analysis unit 32 may display the color of the pictogram 60D of the person in a color associated in advance with “need a rest”.
(B3) In a case where the data analysis unit 32 specifies the action of the person 2 as “inspection”, specifies the posture of the person 2 as “standing”, specifies that the temporal change in the respiratory rate of the person 2 is relatively large (for example, the respiratory rate rapidly increases and is unstable), and specifies that the temporal change in the heart rate of the person 2 is relatively large (for example, the heart rate rapidly increases and is unstable), the data analysis unit 32 determines that the physical condition of the person 2 is “need rescue” since the posture does not match the normal posture described above for the action, and respiratory rate and the heart rate do not match any of the normal respiratory rate and heart rate described above for the action. Then, the data analysis unit 32 displays the pictogram 60D indicating the action of “inspection” of the person 2 and a “!” mark 62C indicating that the physical condition is “need rescue”. At this time, the data analysis unit 32 may display the color of the pictogram 60D of the person 2 in a color associated in advance with “need rescue”.

As a result, the user can easily confirm at which position each person working in the warehouse is performing what kind of action and what physical condition each person has, by viewing the pictogram 60 and the mark 62 displayed on the display device 50.

The expression “mark” is an example, and any expression such as a character, a number, a sign, a pattern, or a pictogram may be used as long as the physical condition can be distinguished.

### <Display of Set Action>

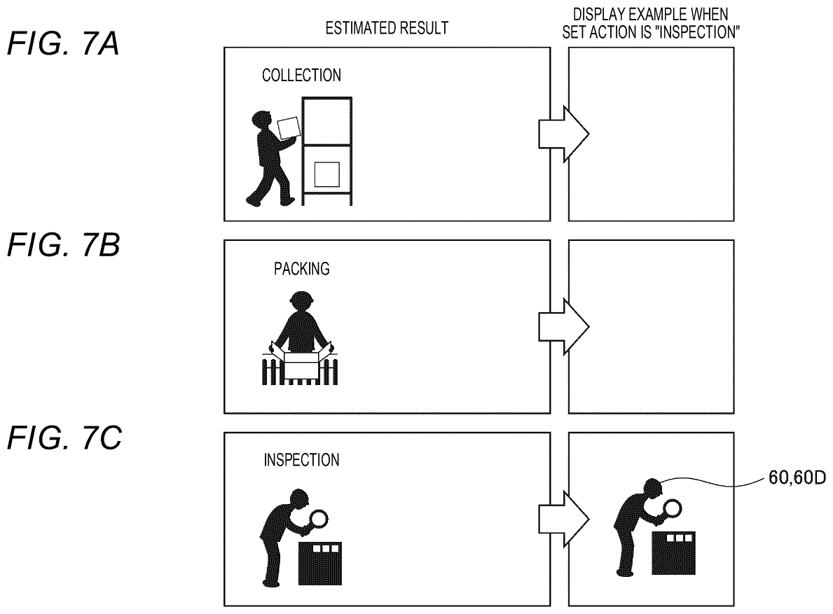

FIGS. 7A to 7C are diagrams illustrating an example of displaying a set action according to the present embodiment.

The user sets a display condition related to the action in the data analysis unit 32 in advance through the input device 40. The data analysis unit 32 specifies the action of the person 2 from the action data in the action data storage unit 29. The data analysis unit 32 displays the pictogram 60 indicating the action when the specified action matches the display condition set above, and does not display the pictogram 60 indicating the action when the specified action does not match the display condition set above. Hereinafter, a specific example will be described.

For example, the user performs setting to display the action of “inspection” and not to display other actions as the display condition through the input device 40. Then, it is assumed that the data analysis unit 32 estimates the action of the first person 2 as “collection” as illustrated in FIG. 7A, estimates the action of the second person 2 as “packing” as illustrated in FIG. 7B, and estimates the action of the third person 2 as “inspection”as illustrated in FIG. 7C.

In this case, as illustrated in FIG. 7C, the data analysis unit 32 displays the pictogram 60D indicating the action of “inspection” for the third person 2 whose action is estimated to be “inspection” on the area map 51, and does not display the pictogram 60 for the first person 2 whose action is estimated to be “collection” and the second person whose action is estimated to be “packing”on the area map 51 as illustrated in FIGS. 7A to 7C.

As a result, the user can easily confirm where each person 2 performing the action set as the display condition by the user is located by viewing the pictogram 60 displayed on the display device 50. For example, when a large number of persons 2 are present in the monitoring area 1 and the display of the area map 51 is complicated, this setting can eliminate the complexity of the display.

### <Display of Estimation Accuracy of Action>

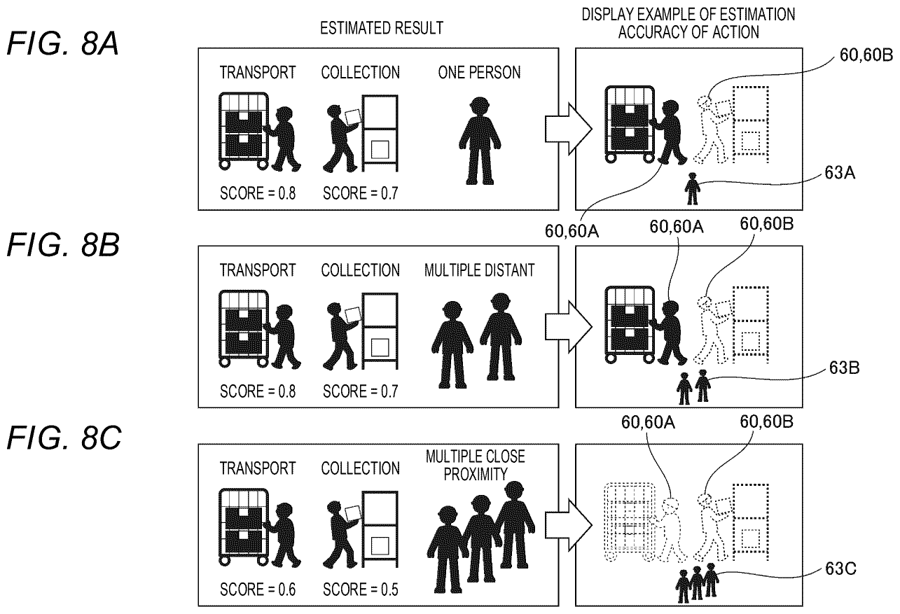

FIGS. 8A to 8C are diagrams illustrating a display example of the estimation accuracy of an action according to the present embodiment.

The data analysis unit 32 specifies the action of the person 2 from the action data in the action data storage unit 29. The data analysis unit 32 displays the pictogram 60 indicating the specified action on the display device 50.

At this time, when there are a plurality of actions having a score equal to or greater than a predetermined threshold value in the action data, the data analysis unit 32 may display the pictograms 60 each indicating respective one of the plurality of actions together. In addition, the data analysis unit 32 may display the pictogram 60 indicating the action having the highest score among the plurality of pictograms 60 in a color or brightness different from those of the pictograms 60 indicating other actions.

When there is no action having a score equal to or greater than the predetermined threshold value in the action data, the data analysis unit 32 may display the pictogram 60 indicating one or more actions from the top of the score in a color or brightness different from that of the pictogram 60 displayed when the score is equal to or greater than the predetermined threshold value. Hereinafter, a specific example will be described.

For example, as illustrated in FIG. 8A, in the action data of a certain person in the action data storage unit 29, that the score of the action of “transport” is 0.8, the score of the action of “collection” is 0.7, and the density of the person 2 is “one person”. In this case, both the score of the action of “transport” and the score of the action of “collection” are equal to or greater than the predetermined threshold value (for example, 0.7), and it is difficult to determine which is correct. In this case, as illustrated in FIG. 8A, the data analysis unit 32 may display both the pictogram 60A indicating the action of “transport” and the pictogram 60B indicating the action of “collection” on the area map 51. Then, the data analysis unit 32 may display the pictogram 60A indicating the action of “transport” having a relatively high score with low brightness (darker) and the pictogram 60B indicating the action of “collection” having a relatively low score with high brightness (lighter). The data analysis unit 32 may display a pictogram 63A indicating that the density of the person 2 is “one person” together with the pictogram 60 indicating the action.

Accordingly, the user can easily confirm the estimation accuracy of the action of each person 2 by viewing the pictogram 60 displayed on the display device 50.

For example, as illustrated in FIG. 8B, in the action data of a certain person 2 in the action data storage unit 29, the score of the action of “transport” is 0.8, the score of the action of “collection” is 0.7, and the density of the person 2 is “multiple distant”. In this case, both the score of the action of “transport” and the score of the action of “collection” are equal to or greater than the predetermined threshold value (for example, 0.7), and it is difficult to determine which is correct. In this case, as illustrated in FIG. 8B, the data analysis unit 32 may display the pictogram 60A indicating the action of “transport” and the pictogram 60B indicating the action of “collection” together in the area map 51. Then, the data analysis unit 32 may display the pictogram 60A indicating the action of “transport” having a relatively high score with low brightness (darker) and the pictogram 60B indicating the action of “collection” having a relatively low score with high brightness (lighter). The data analysis unit 32 may display a pictogram 63B indicating that the density of the person 2 is “multiple distant” together with the pictogram 60 indicating the action.

Accordingly, the user can easily confirm the estimation accuracy of the action of the person 2 by viewing the pictogram 60 displayed on the display device 50. In addition, the user can assume that there is a possibility that the estimation accuracy of the action is low as compared with a case where the pictogram 63A indicating that the density of the person 2 is “one person” is displayed by viewing the pictogram 63B indicating that the density of the person 2 is “multiple distant”.

For example, as illustrated in FIG. 8C, in the action data in the action data storage unit 29, the score of the action of “transport” is 0.6, the score of the action of “collection” is 0.5, and the density of the persons 2 is “multiple close proximity”. In this case, both the score of the action of “transport” and the score of the action of “collection” are less than the predetermined threshold value (for example, 0.7), it is difficult to determine which is correct, and both may not be correct. In this case, as illustrated in FIG. 8C, the data analysis unit 32 may display, in the area map 51, the pictogram 60A indicating the action of “transport” and the pictogram 60B indicating the action of “collection” in a descending order of the score. Since both scores are relatively low, the data analysis unit 32 may display both the pictogram 60A indicating the action of “transport” and the pictogram 60B indicating the action of “collection” with low (light) brightness. In addition, the data analysis unit 32 may display a pictogram 63C indicating that the density of the person 2 is “multiple close proximity” together with the pictogram 60 indicating the action.

Accordingly, the user can easily confirm the estimation accuracy of the action of the person by viewing the pictogram 60 displayed on the display device 50. In addition, the user can assume that there is a possibility that the estimation accuracy of the action is low as compared with a case where the pictograms 63A and 63B indicating that the density of the person is “one person” or “multiple distant” are displayed by viewing the pictogram 63C indicating that the density of the person 2 is “multiple close proximity”.

### <Display Setting Screen of Action Appropriateness>

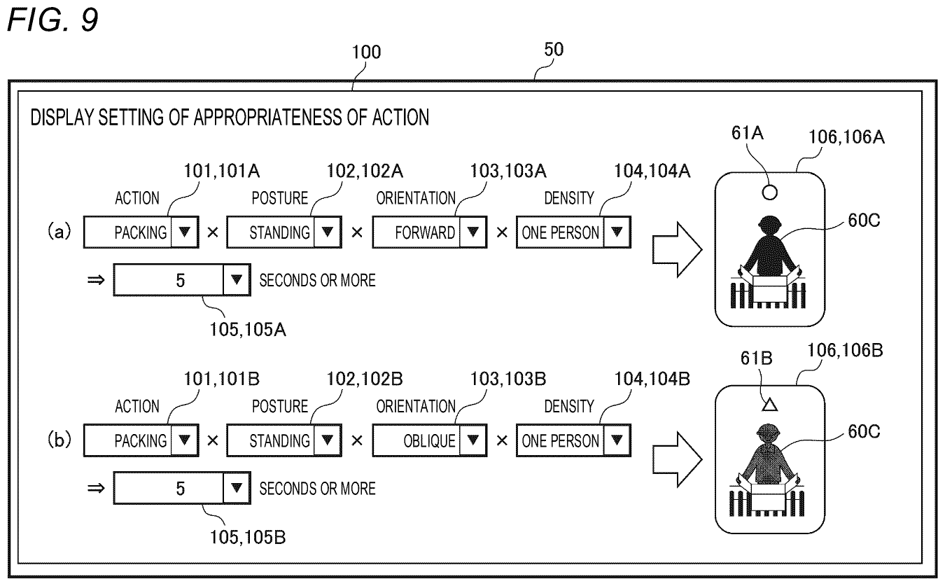

FIG. 9 is a diagram illustrating an example of a screen for setting a display condition for appropriateness of an action according to the present embodiment.

As illustrated in FIG. 9, the data analysis unit 32 may display a screen for setting the display condition of the appropriateness of the action (hereinafter, referred to as a display setting screen 100 of action appropriateness) on the display device 50. The display setting screen 100 of the action appropriateness includes an action selection area 101, a posture selection area 102, an orientation selection area 103, a density selection area 104, a time selection area 105, and a pictogram and mark set selection area 106.

For example, as illustrated in the (a) portion of FIG. 9, the user selects “packing” in an action selection area 101A, selects “standing” in a posture selection area 102A, selects “forward” in an orientation selection area 103A, selects “one person” in a density selection area 104A, selects “5 seconds” in a time selection area 105A, and selects a set of the pictogram 60C indicating “packing” and a “○” mark 61A indicating that the action is “appropriate” in a pictogram and mark set selection area 106A through the input device 40. In this case, as illustrated in FIG. 5A, for a certain person, when a state in which the action is specified as “packing”, the posture is specified as “standing”, the orientation is specified as “forward”, and the density of the person 2 is specified as “one person” continues for “5 seconds” or more, the data analysis unit 32 displays the pictogram 60C indicating the action of “packing” and the “○” mark 61A indicating that the action is “appropriate” together according to the display condition of the (a) portion of FIG. 9.

For example, as illustrated in the (b) portion of FIG. 9, the user selects “packing” in an action selection area 101B, selects “standing” in a posture selection area 102B, selects “oblique” in an orientation selection area 103B, selects “one person” in a density selection area 104B, selects “5 seconds” in a time selection area 105B, and selects a set of the pictogram 60C indicating “packing” and a “Δ” mark 61B indicating that the action is “slightly inappropriate” in a pictogram and mark set selection area 106B through the input device 40. In this case, as illustrated in FIG. 5B, for a certain person 2, when a state in which the action is specified as “packing”, the posture is specified as “standing”, the orientation is specified as “oblique”, and the density of the person 2 is specified as “one person” continues for “5 seconds” or more, the data analysis unit 32 displays the pictogram 60C indicating the action of “packing” and the “Δ” mark 61B indicating that the action is “slightly inappropriate” together according to the display condition of the (b) portion of FIG. 9.

In this way, the user can freely set the display condition of the appropriateness of the action.

### <Display Setting Screen of Physical Condition>

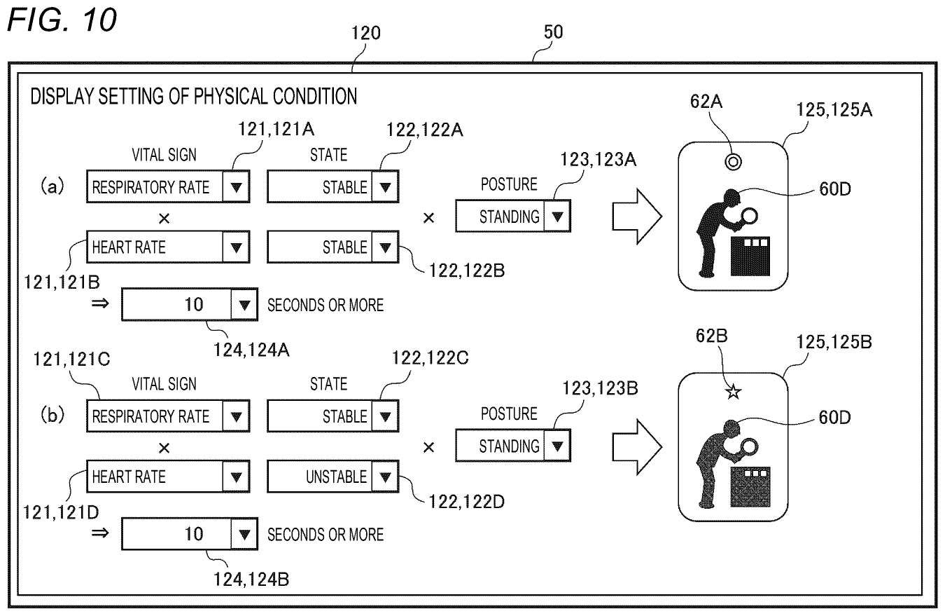

FIG. 10 is a diagram illustrating an example of a screen for setting a display condition of the physical condition according to the present embodiment.

As illustrated in FIG. 10, the data analysis unit 32 may display a screen for setting a display condition of the physical condition (hereinafter, referred to as a display setting screen 120 of a physical condition) on the display device 50.

The display setting screen 120 of the physical condition displays a vital signs selection area 121, a vital signs state selection area 122, a posture selection area 123, a time selection area 124, and a pictogram and mark set selection area 125. As illustrated in FIG. 10, two or more sets of the vital signs selection area 121 and the vital signs state selection area 122 may be provided.

For example, as illustrated in the (a) portion of FIG. 10, the user selects “respiratory rate” in a vital signs selection area 121A of a first set, selects “stable” in a vital signs state selection area 122A of the first set, selects “heart rate” in the vital signs selection area 121B of a second set, selects “stable” in a vital signs state selection area 122B of the second set, selects “standing” in the posture selection area 123A, selects “10 seconds” in the time selection area 124A, and selects a set of the pictogram 60D indicating “inspection” and a “⊚” mark 62A indicating “normal” in a pictogram and mark set selection area 125A through the input device 40. In this case, as illustrated in FIG. 6A, for a certain person, when a state in which the action is specified as “inspection”, the posture is specified as “standing”, the temporal change in the respiratory rate is specified as “stable”, and the temporal change in the heart rate is specified as “stable” continues for “10 seconds” or more, the data analysis unit 32 displays the pictogram 60D indicating the action of “inspection” and the “⊚” mark 62A indicating that the physical condition is “normal”together according to the display condition of the (a) portion of FIG. 10.

For example, as illustrated in the (b) portion of FIG. 10, the user selects “respiratory rate” in a vital signs selection area 121C of a first set, selects “stable” in a vital signs state selection area 122C of the first set, selects “heart rate” in a vital signs selection area 121D of a second set, selects “unstable” in a vital signs state selection area 122D of the second set, selects “standing” in a posture selection area 123B, selects “10 seconds” in a time selection area 124B, and selects a set of the pictogram 60D indicating “inspection” and a “☆” mark 62B indicating “need a rest” in a pictogram and mark set selection area 125B through the input device 40. In this case, as illustrated in FIG. 6B, for a certain person, when a state in which the action is specified as “inspection”, the posture is specified as “standing”, the temporal change in the respiratory rate is specified as “stable”, and the temporal change in the heart rate is specified as “unstable” continues for “10 seconds” or more, the data analysis unit 32 displays the pictogram 60D indicating the action of “inspection” and the “☆” mark 62B indicating that the physical condition is “need a rest” together according to the display condition of the (b) portion of FIG. 10.

Instead of selecting the state “stable”, a range of vital values corresponding to “stable” (for example, an upper limit threshold value and a lower limit threshold value of the range) may be input. Instead of selecting the state “unstable”, an upper limit threshold value and a lower limit threshold value for determining that the state is unstable may be input. In this case, when the vital value is greater than the upper limit threshold value or smaller than the lower limit threshold value, it may be determined to be unstable.

In this way, the user can freely set the display condition of the physical condition.

### <Selection Screen of Use>

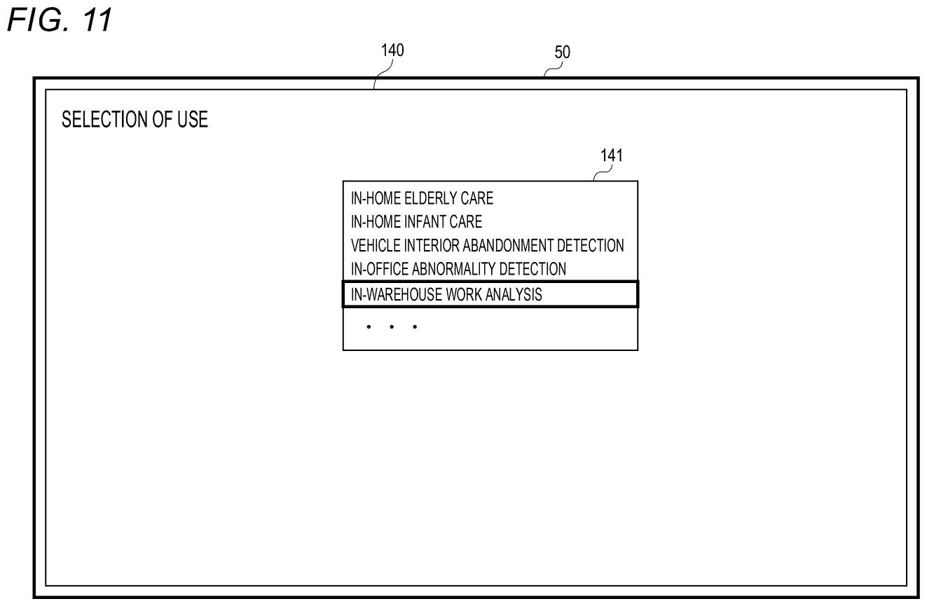

FIG. 11 is a diagram illustrating an example of a screen for selecting a use according to the present embodiment.

As illustrated in FIG. 11, the data analysis unit 32 may display a screen for selecting a use of the person analysis system 10 (hereinafter, referred to as a use selection screen 140) on the display device 50.

A selection list 141 of uses is displayed on the use selection screen 140. Each use is associated in advance with the display condition described above suitable for the use.

For example, when the user selects one use from the selection list 141 of uses through the input device 40 as illustrated in FIG. 11, the data analysis unit 32 reads and sets the display condition associated with the selected use in advance.

This allows the user to set the display condition more easily.

### <Setting Screen of Detection Sensitivity>

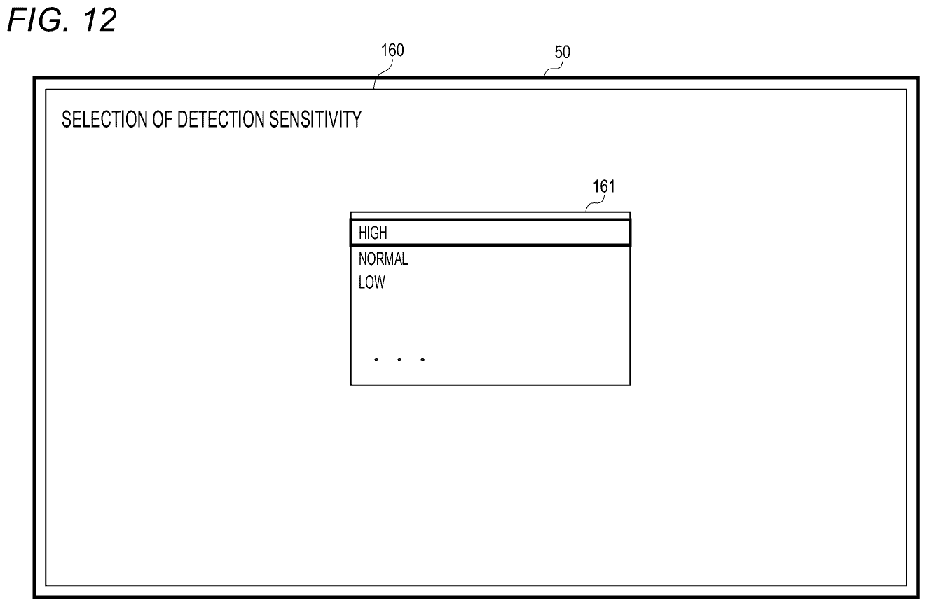

FIG. 12 is a diagram illustrating an example of a screen for setting detection sensitivity according to the present embodiment.

The data analysis unit 32 displays a screen for selecting the detection sensitivity of the action (hereinafter, referred to as a detection sensitivity selection screen 160) on the display device 50.

The detection sensitivity selection screen 160 displays a selection list 161 of detection sensitivity levels. For example, as illustrated in FIG. 12, the selection list 161 in which the detection sensitivity is selectable from three of “high”, “normal”, and “low”is displayed.

The data analysis unit 32 determines sensitivity of the display of the pictogram 60 indicating the action with respect to the action set as a display target illustrated in FIGS. 7A to 7C according to the selected detection sensitivity level.

For example, when the user selects the detection sensitivity of “high” from the selection list 161 of detection sensitivity levels through the input device 40, a first threshold value associated in advance with the detection sensitivity of “high” is set as a threshold value for the score of the action set as the display target.

For example, when the user selects the detection sensitivity of “normal” from the selection list 161 of detection sensitivity levels through the input device 40, a second threshold value associated in advance with the detection sensitivity of “normal” is set as the threshold value for the score of the action set as the display target.

For example, when the user selects the detection sensitivity of “low” from the selection list 161 of detection sensitivity levels through the input device 40, a third threshold value associated in advance with the detection sensitivity of “low” is set as the threshold value for the score of the action set as the display target.

Here, the first threshold value is smaller than the second threshold value, and the second threshold value is smaller than the third threshold value.

Accordingly, for example, when the detection sensitivity of “high” is selected, the data analysis unit 32 determines to display the pictogram 60 indicating the action in the display of the set action illustrated in FIGS. 7A to 7C even when the score of the action is relatively low (for example, a score smaller than the second threshold value but greater than the first threshold value). That is, the higher the detection sensitivity, the more easily the pictogram 60 indicating the set action is displayed, and the lower the detection sensitivity, the less easily the pictogram 60 indicating the set action is displayed.

In this way, the user can freely set the detection sensitivity related to the action of the person 2. That is, the user can freely set the sensitivity of the display of the pictogram 60 indicating the action.

### <Estimation of Mental State of Person>

The data analysis unit 32 may estimate a mental state of the person 2 based on the action data in the action data storage unit 29 and the vital data in the vital data storage unit 31. For example, when the data analysis unit 32 specifies the posture as “standing” from the action data and specifies a rapid increase in the heart rate from the vital data, the data analysis unit 32 may estimate the mental state of the person 2 as “high stress”. Further, when estimating the mental state of the person 2, the data analysis unit 32 may improve the estimation accuracy by using at least one of the thermal data and the environment data. For example, when the data analysis unit 32 specifies a sudden increase in the body temperature of the person 2 from the thermal data and specifies that the temperature in the warehouse is an uncomfortable temperature (for example, a temperature equal to or higher than a predetermined threshold value) from the environment data, the data analysis unit 32 may calculate the estimation accuracy of the mental state of the person 2 being “high stress” to be higher than the estimation accuracy when the mental state is “high stress” without using the thermal data and the environment data.

In this way, by estimating the mental state of the person 2 using not only the information obtained from the radar device 11 but also information obtained from another sensor different from the radar device 11, such as the thermal sensor 12 or the environment sensor 13, the estimation accuracy can be improved. Examples of the mental state of the person 2 include a level of “sleepiness”, a level of “tension”, a level of “relaxation”, and the like, in addition to the level of “stress”described above.

### Hardware Configuration

Functional blocks of the person analysis device 20 described above can be realized by a computer program.

FIG. 13 is a diagram illustrating a hardware configuration example of an information processing device (computer) that realizes functional blocks of the person analysis device 20 according to the present disclosure by a computer program.

The information processing device 1000 includes a processor 1001, a memory 1002, a storage 1003, an input interface (I/F) 1004, an output I/F 1005, a communication I/F 1006, a graphics processing unit (GPU) 1007, a reading I/F 1008, and a bus 1009.

The processor 1001, the memory 1002, the storage 1003, the input I/F 1004, the output I/F 1005, the communication I/F 1006, the graphics processing unit (GPU) 1007, and the reading I/F 1008 are connected to the bus 1009 and can bidirectionally transmit and receive data via the bus 1009.

The processor 1001 is a device that executes a computer program stored in the memory 1002 to implement the functional blocks described above. Examples of the processor 1001 include a central processing unit (CPU), a micro processing unit (MPU), a controller, a large scale integration (LSI), an application specific integrated circuit (ASIC), a programmable logic device (PLD), and a field-programmable gate array (FPGA).

The memory 1002 is a device that stores a computer program and data handled by the information processing device 1000. The memory 1002 may include a read-only memory (ROM) and a random access memory (RAM).

The storage 1003 is a device that is implemented by a nonvolatile storage medium, and that stores a computer program and data handled by the information processing device 1000. Examples of the storage 1003 include a hard disk drive (HDD) and a solid state drive (SSD).

The input I/F 1004 is connected to the input device 40 that receives an input from a user, and transmits data received from the input device 40 to the processor 1001.

The output I/F 1005 is connected to the display device 50 and transmits data received from the processor 1001 to the display device 50.

The communication I/F 1006 is connected to the communication network 14 and transmits and receives data to and from another device via the communication network 14. The communication I/F 1006 may support either wired communication or wireless communication. Examples of the wired communication include Ethernet (registered trademark). Examples of the wireless communication include Wi-Fi (registered trademark), Bluetooth (registered trademark), long term evolution (LTE), 4G, and 5G.

The GPU 1007 is a device that processes image depiction at a high speed. The GPU 1007 may be used for processing (for example, deep learning processing) of artificial intelligence (AI).

The reading I/F 1008 is connected to an external storage medium and reads data from the external storage medium. Examples of the external storage medium include a digital versatile disk read only memory (DVD-ROM) and a universal serial bus (USB) memory.

The functional blocks of the person analysis device 20 may be implemented as an LSI that is an integrated circuit. These functional blocks may be individually integrated into one chip, or may include some or all of these functions into one chip. Here, the function is implemented as an LSI. Alternatively, the function may also be called an IC, a system LSI, a super LSI, or an ultra LSI depending on the degree of integration. Further, if an integrated circuit technique that replaces the LSI emerges due to an advancement in semiconductor technique or another derived technique, the functional blocks may naturally be integrated using that technique.

### Summary of Present Disclosure

The following techniques are disclosed based on the above description of the embodiment.

### <Technique 1>

The person analysis system 10 includes at least one radar device 11 installed in the monitoring area 1 and configured to output observation data including a result of observing the monitoring area 1 by a radar method, and the person analysis device 20 configured to execute, based on the observation data, the first process (for example, the process of the target data generation unit 26) of detecting a position of each person 2 present in the monitoring area 1 and the second process (for example, the process of the action data generation unit 28) of estimating an action of the detected person 2 and display information indicating the position and the action of the person 2 on the predetermined display device 50.

Accordingly, it is possible to display the position where each person 2 is present in the monitoring area 1 and the action of each person 2 while protecting privacy.

### <Technique 2>

In the person analysis system 10 according to Technique 1, the person analysis device 20 generates three-dimensional point cloud data based on the observation data, detects the position of the person 2 based on the distribution of the point cloud data in the first process, and estimates the action of the person 2 based on a temporal change in the point cloud data in the second process.

Accordingly, the position of each person 2 can be detected by the first process, and the action of each person 2 can be estimated by the second process.

### <Technique 3>

In the person analysis system 10 according to Technique 1 or 2, in the first process, the position of the person 2 is detected using a first neural network trained in advance to output the position where the person 2 is present when the point group data is input, and in the second process, the action of the person 2 is estimated using a second neural network trained in advance to output the action of the person 2 when the temporal change in the point group data is input. Accordingly, the position of each person 2 can be detected using the first neural network, and the action of each person 2 can be estimated using the second neural network.

### <Technique 4>

In the person analysis system 10 according to any one of Techniques 1 to 3, the point cloud data includes at least coordinate information indicating three-dimensional coordinates of each point and motion information indicating a direction and a speed of movement of each point, and in the second process, the action of the person 2 is estimated by inputting at least the motion information to the second neural network.

In this way, by estimating the action of the person 2 using the motion information, the estimation accuracy of the action is improved.

### <Technique 5>

In the person analysis system 10 according to any one of Techniques 2 to 4, the person analysis device 20 displays the area map 51 corresponding to the monitoring area 1, and displays the pictogram 60 indicating the estimated action of the person 2 at the detected position of the person 2 in the area map 51.

As a result, the user can easily confirm at which position the person 2 is performing what kind of action by viewing the pictogram 60 indicating the displayed action.

### <Technique 6>

In the person analysis system 10 according to any one of Techniques 2 to 5, the person analysis device 20 further detects a posture and an orientation of the person 2 based on the distribution of the point group data in the first process, determines appropriateness of the action of the person 2 based on the estimated action of the person 2 and the detected posture and orientation of the person 2, and displays the pictogram 60 indicating the action of the person 2 and information indicating a determination result of the appropriateness of the action of the person 2 together.

As a result, the user can easily confirm at which position each person 2 is performing what kind of action and whether the person 2 is taking an appropriate action by viewing the pictogram 60 indicating the displayed action and the information indicating the determination result of the appropriateness.

### <Technique 7>

In the person analysis system 10 according to any one of Techniques 2 to 6, the person analysis device 20 estimates a vital sign of the person 2 based on the point cloud data and the observation data, determines a physical condition of the person based on the estimated action of the person 2, the detected posture of the person 2, and the estimated vital sign of the person 2, and displays the pictogram 60 indicating the action of the person 2 and information indicating a determination result of the physical condition of the person together.

As a result, the user can easily confirm at which position each person 2 is performing what kind of action and what physical condition each person has, by viewing the pictogram 60 indicating the displayed action and the information indicating the determination result of the physical condition.

### <Technique 8>

In the person analysis system 10 according to any one of Techniques 2 to 7, the person analysis device 20 displays the pictogram 60 indicating the action of the person 2 when the estimated action of the person 2 matches a display condition for the action set in advance, and does not display the pictogram 60 indicating the action of the person 2 when the estimated action of the person 2 does not match the display condition.

As a result, the pictogram 60 that does not match the display condition set in advance by the user is not displayed, and the pictogram 60 that matches the display condition is displayed, so that the user can quickly recognize the person who is performing the action matching the display condition.

### <Technique 9>

In the person analysis system 10 according to Technique 3, the second neural network is configured to output a score indicating reliability of estimation of an action for each type of action, and the person analysis device 20 displays the pictograms 60 each indicating respective one of a plurality of actions together when there are the plurality of actions having the score equal to or greater than a predetermined threshold value.

As a result, the user can recognize that there is a high possibility that the person 2 is taking one of the actions indicated by the plurality of pictograms 60 by viewing the plurality of displayed pictograms 60.

### <Technique 10>

In the person analysis system 10 according to Technique 9, the person analysis device 20 displays the pictogram 60 indicating an action having the highest score among the plurality of actions in a color or brightness different from that of the pictogram 60 indicating another action.

Accordingly, the user can confirm at a glance which pictogram 60 among the plurality of displayed pictograms 60 has higher estimation accuracy.

### <Technique 11>

In the person analysis system 10 according to Technique 3, the second neural network is configured to output, for each type of action, a score indicating the reliability of estimation of the action, and the person analysis device 20 displays the pictogram 60 indicating one or more actions from the top of the score in a color or brightness different from that of the pictogram 60 displayed when the score is equal to or greater than the predetermined threshold value in a case where there is no action having a score equal to or greater than the predetermined threshold value.

Accordingly, the user can confirm at a glance that the estimation accuracy of the action indicated by the pictogram 60 may be low by viewing the plurality of displayed pictograms 60.

### <Technique 12>

In the person analysis system 10 according to any one of Techniques 1 to 11, the person analysis device 20 specifies a density of the person 2 with respect to another person 2 based on the detected position of the person 2, and displays information indicating the density of the person 2 together with the pictogram 60 indicating the action of the person 2.

Accordingly, the user can grasp a level of the estimation accuracy of the action indicated by the pictogram by viewing the displayed pictogram 60 and the information indicating the density of the person.

### <Technique 13>

A person analysis method includes acquiring observation data including a result of observing a monitoring area 1 by a radar method from at least one radar device 11 installed in the monitoring area 1, executing the first process (for example, the process of the target data generation unit 26) of detecting a position of each person 2 present in the monitoring area 1 and the second process (for example, the process of the action data generation unit 28) of estimating an action of the detected person 2 based on the observation data, and displaying information indicating the position and the action of the person 2 on the predetermined display device 50.

Accordingly, it is possible to display the position where each person 2 is present in the monitoring area 1 and the action of each person 2 while protecting privacy.

### <Technique 14>

A person analysis program causes a computer to execute the person analysis method according to Technique 13.

Accordingly, it is possible to display the position where each person 2 is present in the monitoring area 1 and the action of each person 2 while protecting privacy.

Although the embodiment has been described above with reference to the accompanying drawings, the present disclosure is not limited thereto. It is apparent to those skilled in the art that various modifications, corrections, substitutions, additions, deletions, and equivalents can be conceived within the scope described in the claims, and it is understood that such modifications, corrections, substitutions, additions, deletions, and equivalents also fall within the technical scope of the present disclosure. In addition, constituent elements in the embodiment described above may be freely combined without departing from the gist of the invention.

The present application is based on a Japanese Patent Application (Japanese Patent Application No. 2022-207036) filed on Dec. 23, 2022, and the contents thereof are incorporated herein by reference.

### INDUSTRIAL APPLICABILITY

The technology of the present disclosure is useful when analyzing the position, action, and the like of a person while protecting privacy.

### REFERENCE SIGNS LIST

1 monitoring area
2 person
10 person analysis system
11 radar device
12 thermal sensor
13 environment sensor
14 communication network
20 person analysis device
21 IQ data storage unit
22 thermal data storage unit
23 environment data storage unit
24 point cloud data generation unit
25 point cloud data storage unit
26 target data generation unit
27 target data storage unit
28 action data generation unit
29 action data storage unit
30 vital data generation unit
31 vital data storage unit
32 data analysis unit
40 input device
50 display device
51 area map
60, 60A, 60B, 60C, 60D pictogram
61, 61A, 61B, 61C mark
62, 62A, 62B, 62C mark
63A, 63B, 63C pictogram
100 display setting screen of action appropriateness
101 action selection area
102 posture selection area
103 orientation selection area
104 density selection area
105 time selection area
106 pictogram and mark set selection area
120 display setting screen of physical condition
121, 121A, 121B vital signs selection area
122, 122A, 122B vital signs state selection area
123 posture selection area
124 time selection area
125 pictogram and mark set selection area
140 use selection screen
141 selection list of uses
160 detection sensitivity selection screen
161 selection list of detection sensitivity levels

1. A person analysis system comprising:
at least one radar device that is installed in a monitoring area and outputs observation data including a result of observing the monitoring area by a radar method; and
a person analysis device that executes, based on the observation data, a first process of detecting a position of each person present in the monitoring area and a second process of estimating an action of the detected person, and displays an area map corresponding to the monitoring area and displays a pictogram indicating the position of the each person and types of action of the each person in the area map on a predetermined display device, wherein
the person analysis device displays the pictogram on the display device when the action of the each person matches an action set in advance.

2. The person analysis system according to claim 1, wherein
the person analysis device
generates three-dimensional point cloud data based on the observation data,
detects the position of the person based on a distribution of the point cloud data in the first process, and
estimates the action of the person based on a temporal change in the point cloud data in the second process.

3. The person analysis system according to claim 2, wherein
in the first process, the position of the person is detected using a first neural network trained in advance to output the position where the person is present when the point group data is input, and
in the second process, the action of the person is estimated using a second neural network trained in advance to output the action of the person when the temporal change in the point group data is input.

4. The person analysis system according to claim 3, wherein
the point cloud data includes at least coordinate information indicating three-dimensional coordinates of each point and motion information indicating a direction and a speed of movement of each point, and
in the second process, the action of the person is estimated by inputting at least the motion information to the second neural network.

5. (canceled)

6. The person analysis system according to claim 2, wherein
the person analysis device
further detects a posture and an orientation of the person based on the distribution of the point cloud data in the first process,
determines appropriateness of the action of the person based on the estimated action of the person and the detected posture and orientation of the person, and
displays a pictogram indicating the action of the person and information indicating a determination result of the appropriateness of the action of the person together.

7. The person analysis system according to claim 2, wherein
the person analysis device
estimates a vital sign of the person based on the point cloud data and the observation data,
determines a physical condition of the person based on the estimated action of the person, the detected posture of the person, and the estimated vital sign of the person, and
displays the pictogram and information indicating a determination result of the physical condition of the person together.

8. (canceled)

9. The person analysis system according to claim 3, wherein
the second neural network outputs, for each type of action, a score indicating reliability of estimation of the action, and
the person analysis device displays a plurality of pictograms together when there are the plurality of actions having the score equal to or greater than a predetermined threshold value.

10. The person analysis system according to claim 9, wherein
the person analysis device displays the pictogram indicating an action having a highest score among the plurality of actions in a color or brightness different from that of the pictogram indicating another action.

11. The person analysis system according to claim 3, wherein
the second neural network outputs, for each type of action, a score indicating reliability of estimation of the action, and
the person analysis device displays one or more pictograms from a top of the score in a color or brightness different from that of a pictogram displayed when the score is equal to or greater than a predetermined threshold value, in a case where there is no action having a score equal to or greater than the predetermined threshold value.

12. The person analysis system according to claim 2, wherein
the person analysis device specifies a density of the person with respect to another person based on the detected position of the person, and displays information indicating the density of the person together with the pictogram.

13. A person analysis method comprising:
in an information processing device, acquiring observation data including a result of observing a monitoring area by a radar method from at least one radar device installed in the monitoring area;
executing a first process of detecting a position of each person present in the monitoring area and a second process of estimating an action of the detected person based on the observation data; and
displaying an area map corresponding to the monitoring area on a predetermined display device, and displaying a pictogram indicating the position of the each person and types of action of the each person in the area map when the action of the each person matches an action set in advance.

14. (canceled)
